(19) United States
(12) Patent Application Publication
(10) Pub. No.: US 2025/0237432 A1
(43) Pub. Date: Jul. 24, 2025

(54) LAMP ARRANGEMENT AND METHOD FOR CURING MATERIAL

(71) Applicant: HEDSON TECHNOLOGIES AB, Arlöv (SE)

(72) Inventor: Linus EKFELDT, Torslanda (SE)

(73) Assignee: HEDSON TECHNOLOGIES AB, Arlöv (SE)

(21) Appl. No.: 18/855,505

(22) PCT Filed: Mar. 13, 2023
(86) PCT No.: PCT/IB2023/052399

§ 371 Date: Oct. 9, 2024

(30) Foreign Application Priority Data
Apr. 12, 2022 (SE) 2230109-7

(51) Int. Cl. F26B 3/30; B05D 3/02; H05B 1/02; H05B 3/00

(52) U.S. Cl. CPC F26B 3/30; B05D 3/0263; H05B 1/0247; H05B 3/0038

(57) ABSTRACT

In general terms the present disclosure proposes a lamp arrangement for curing a material, the lamp arrangement including at least one lamp unit, wherein each of the at least one lamp unit has at least one light source configured to emit a radiation of a pre-defined intensity, and at least one reflector; and a controller configured to control at least one parameter to provide the desired curing of the material.

### TECHNICAL FIELD

This invention relates to curing arrangements. In particular, though not exclusively, this invention relates to a lamp arrangement and a method for curing a material.

### BACKGROUND

Curing, such as paints or similar materials, is a common post-processing technique that is achieved by radiating the curing material with a radiation. Typically, Infrared curing, namely as IR curing, has found applications in various manufacturing industries, such as automobile industry, fashion industry, art industry, and so forth. Notably, IR curing may be used for curing paints, inks, adhesives, coatings, and so forth.

Moreover, the IR curing of a material may include applying radiant light energy within a line of sight thereof. However, factors such as distance between IR curing arrangement and the material, height of the material, intensity of the IR, and so forth, affect a desired curing of the material. Moreover, the conventional IR curing arrangements may fail to completely cure the material. Furthermore, only one part, that is withing the line of sight of the conventional IR arrangements may be cured at a time, thereby resulting in an extended curing time for the entire curing process.

It will be appreciated that in order to circumvent the aforementioned drawback of the conventional IR curing arrangements, multiple IR curing arrangements may be used parallelly. Notably, multiple IR curing arrangements enable achieving a smooth and even curing of the material. However, multiple IR curing arrangements may considerably increase power consumption as well as process cost. Additionally, the multiple IR curing arrangements may use radiations of only two wavelengths that may result in ineffective curing of the material.

Therefore, in light of the foregoing discussion, there exists a need to overcome the aforementioned drawbacks associated with conventional curing arrangements.

### SUMMARY

A first aspect of the invention provides a lamp arrangement for curing a material, the lamp arrangement comprising a controller and two or more lamp units, wherein each of the at two or more lamp units comprises
a first light source configured to emit radiation of a first wavelength and
a second light source configured to emit radiation of a second wavelength, wherein
at least a first one of the two or more lamp units is arranged in a first direction and at least a second one of the two or more lamp units is arranged in a second direction, wherein the second direction is orthogonal to the first direction, and wherein
the controller is configured to control the intensity of the first light source and to control the intensity of the second light source based on the intensity of the first light source to provide a desired curing of the material.

Suitably, the lamp arrangement may be used for curing the material (by radiating the material to be cured with a shortwave radiation and/or a mediumwave radiation. Advantageously, the lamp arrangement employs multiple light sources to be arranged side-by-side and in different directions to achieve a smooth and even curing of the material. This also increases the overall efficiency of the lamp arrangement while reducing the power consumption as compared to the power consumption by multiple curing arrangements.

The term “material” as used herein refers to a composition, such as a paint, an ink, an adhesive, and so forth, to be cured using the shortwave radiation and/or the mediumwave radiation.

The term “light source” as used herein refers to a light source capable of emitting infrared shortwave radiation or infrared mediumwave radiation. Herein a first light source from amongst the two light sources may be configured to emit the shortwave radiation and a second light source from amongst the two light sources may be configured to emit the mediumwave radiation.

In some embodiments, the first wavelength corresponds to infrared medium wave radiation, i.e. a wavelength in the range 1500 to 3000 nanometers 1700 nanometer peak, and the second wavelength corresponds to infrared short wave radiation, i.e. a wavelength in the range 780 to 1500 nanometers.

In some embodiments the first wavelength is in the range 1500 to 2500 nanometers. In some embodiments the first wavelength is in the range 1500 to 2000 nanometers. In some embodiments the first wavelength is in the range 1600 to 1800 nanometers. In some embodiments the first wavelength is in the range 1650 to 1750 nanometers. And, in some embodiments the first wavelength is 1700 nanometers.

In some embodiments the second wavelength is in the range 900 to 1300 nanometers. In some embodiments the second wavelength is in the range 1000 to 1200 nanometers. In some embodiments the second wavelength is in the range 1050 to 1150 nanometers. And, in some embodiments the second wavelength is 1100 nanometers.

In some embodiments, the first wavelength is 500 to 600 nanometers longer than the second wavelength.

It should be noted that the wavelengths given relate to a peak wavelength of the relevant light source.

The lamp unit may be implemented as a cassette having the two light sources implemented as filaments therein. Beneficially, the two filaments in one lamp provides a more even distribution of the emitted radiation.

In some embodiments, one or more of the two or more lamp units thus comprises one lamp having two filaments, the first filament corresponding to the first light source and the second filament corresponding to the second light source. And, in some embodiments, the one or more of the two or more lamp units comprises a cassette and a reflector for both filaments housed in the cassette.

Alternatively, the lamp unit may be implemented as two separate lamps (each having one filament) housed together therein. Herein a first lamp from amongst the two separate lamps may be configured to emit the shortwave radiation and a second lamp from amongst the two separate lamps may be configured to emit the mediumwave radiation.

In some embodiments, one or more of the two or more lamp units comprises two lamps, the first lamp corresponding to the first light source and the second lamp corresponding to the second light source.

And, in some embodiments, the one or more of the two or more lamp units comprises a cassette and a reflector for both lamps housed in the cassette.

Optionally, the at least one lamp unit has a length and a base. Optionally, the length may be longer than the base. In such case, a cross-section of the at least one lamp unit may be any of a trapezoid, a rectangle, an elliptical, and so forth.

In some embodiments, the lamp arrangement further comprises a sensor arrangement, wherein the sensor arrangement is configured to measure at least one parameter selected from: a distance, a temperature, and a humidity, and wherein the controller is configured to control the intensity of the first and second light source based on the measured at least one parameter. Optionally, the sensor arrangement may employ a plurality of sensors, such as a temperature sensor, a humidity sensor, a distance sensor, an illumination sensor, and so forth, for detecting a surrounding temperature, a moisture level of the material being cured, a distance between the lamp arrangement from the material being cured, an intensity of radiation, and so forth. This is advantageous since the at least one parameter detected by the sensor arrangement is used by the controller to regulate the intensity of radiation to achieve desired curing of the material.

In some embodiments, the first direction is vertical and the second direction is horizontal. This allows for an even radiation as the radiation from the various lamp units overlap one another providing an even radiation of the material to be cured.

In some embodiments, at least one first lamp unit is arranged in the first direction and two lamp units are arranged in the second direction on opposite ends of the at least one first lamp unit with regards to the first direction.

In an exemplary implementation, there is one first lamp unit arranged in the first direction.

In another exemplary implementation, there are four first lamp units arranged in the first direction.

This advantageously provides a more even spread of the emitted radiation as the radiation from the vertical lamp units may be overlapped by the radiation from the horizontal lamp units, and vice versa. Additionally, such larger even spread may be achieved using a smaller number of at least two lamp units, thereby reducing the power requirement thereby.

In some embodiments, the intensity of the second light source is in a range of 50-70% of the intensity of the first light source.

In some embodiments, the controller is configured to operate the first light source in a time period comprising a plurality of time slots and to selectively activate or deactivate the first light source in each time slot, wherein the number of time slots where the first light source is activated provides the intensity of the first light source, and to operate the second light source in the same time period and to selectively activate or deactivate the second light source in each time slot, wherein the number of time slots where the second light source is activated provides the intensity of the second light source,

In some such embodiments, the controller is configured to operate the first light source at a first frequency of activation, and to operate the second light source at a second frequency of activation.

And, in some embodiments, the controller is configured to operate the first light source to activate in groups of time slots, and to operate the second light source to activate in groups of time slots.

This is advantageous since the controller activates the light sources emitting shortwave radiation or mediumwave radiation to provide different intensities of radiations, enabling the light sources to run at a full power, at different frequencies or intervals, such that emitting the shortwave radiation at a lower intensity provides a smoother and more even curing, as the shortwaves penetrate deeper into the material and thus heats more effectively.

In this regard, the controller may send a stream of signal comprising 1's indicating that the receiving light source should be activated. In an example, if the first intensity is regarded as 100%, the first signal is a steady stream of 1s (such as 111111111111111) that is transmitted from or controlled by the controller for controlling the lamp arrangement and the activation of the first light sources, and if the second intensity is to be 50% of the first intensity, a second signal is a stream of 1′s and 0′s (such as 1010101010101010,1111000011110000, 1100110011001100, 1111111100000000, and so on) that is transmitted from or controlled by the controller for controlling the lamp arrangement and the activation of the first light sources. In these examples groups of time slots are thus used in a time period for the 1's—the activations. If, for example a time period comprises 8 slots the first example transmits alternating 1's and 0's or the group is simply 1, the second example transmits groups of 4 1's and 4 0's, the third example transmits groups of 2 1's, 2 0's, 2 1's and 2 0′ (alternatively the time period for the third example may be 4 and the groups are 2 1's and 2 0's), and the fourth example transmits one time period of 1's and one time period of 0's or alternatively has a longer time period.

It will be appreciated that an even distribution of 1's and 0's gives a more even curing. In another example, if the first intensity is to be 80%, this may also achieved with inserting 0's in between a sequence of 1's (such as 11110111101111011110), and if the second intensity is still being at 50%, then the second signal is for example 11000110001100011000 or 0100101001010010100.

Optionally, the at least one light source is configured to intermittently emit radiation or blink. Beneficially, such blinking of the at least one light source allows for the heat to transfer through the material to be cured through convection, thereby adding to the even curing that the disclosed lamp arrangement aims to provide.

Beneficially, operating the at least one light source at different frequencies emits radiations with multiple wavelengths that enable efficient curing of the material, without the need for a multiple such arrangements dedicated for curing of the material at a time.

A second aspect of the invention provides a method for use in a lamp arrangement for curing a material, the lamp arrangement comprising two or more lamp units, wherein each of the at two or more lamp units comprises
a first light source configured to emit radiation of a first wavelength and
a second light source configured to emit radiation of a second wavelength, wherein
at least a first one of the two or more lamp units is arranged in a first direction and at least a second one of the two or more lamp units is arranged in a second direction, wherein the second direction is
orthogonal to the first direction, and wherein the method comprises controlling the intensity of the first light source and controlling the intensity of the second light source based on the intensity of the first light source to provide a desired curing of the material.

In some embodiments, the lamp arrangement is a lamp arrangement as disclosed herein.

In some embodiments, the method comprises one or more of the functions of the controller of such a lamp arrangement as disclosed herein.

Throughout the description and claims of this specification, the words “comprise” and “contain” and variations of the words, for example, “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a schematic illustration of a lamp arrangement for curing a material, in accordance with an embodiment of the invention;

FIG. 2 is a schematic illustration of at least one lamp unit, in accordance with an embodiment of the invention;

FIG. 3 is a schematic illustration of a lamp arrangement for curing a material, in accordance with another embodiment of the invention; and

FIG. 4 is a flowchart showing steps of method for curing a material, in accorda nce with an embodiment of the invention.

### DETAILED DESCRIPTION OF EMBODIMENTS

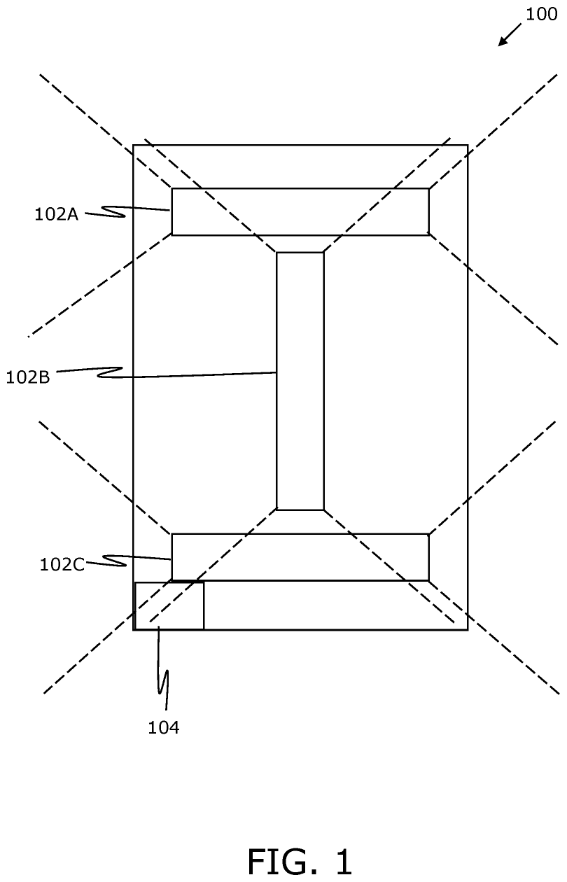

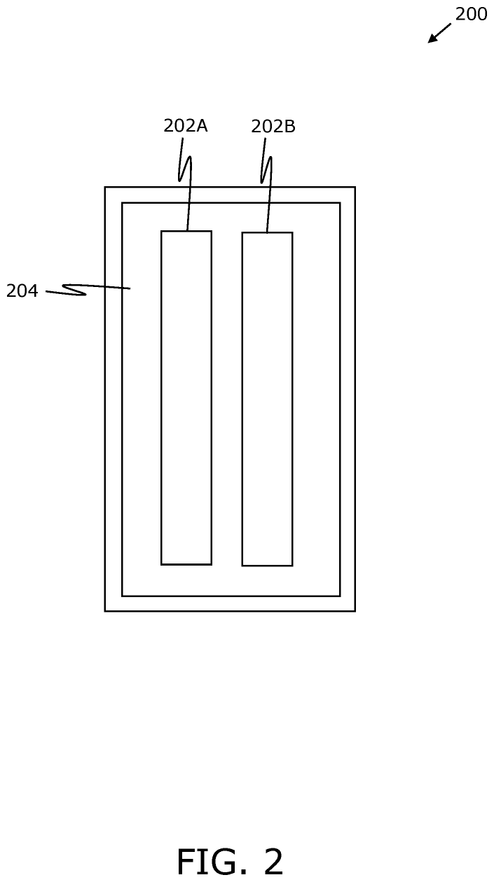

Referring to FIG. 1, shown is a schematic illustration of a lamp arrangement 100 for curing a material, in accordance with an embodiment of the invention. The lamp arrangement 100 comprises a plurality of lamp units, such as a lamp unit 102A, a lamp unit 102B, and a lamp unit 102C. Additionally, each of the lamp units 102A, 102B, and 102C comprises at least one light source (not shown in FIG. 1, but shown in FIG. 2 and referenced 202A, 202B) configured to emit a radiation (depicted as dashed lines) of a pre-defined intensity. In some embodiments at least some of the lamp units comprises at least one reflector (not shown in FIG. 1, but shown in FIG. 2 and referenced 204). The lamp arrangement 100 comprises a controller 104 configured to control at least one parameter to provide the desired curing of the material.

In some embodiments, the plurality of lamp units, such as 102A, 102B, and 102C are arranged in a first and a second direction where the first and second direction are at a pre-defined angle with one another to provide the desired curing of the material. The predefined angle is in some embodiments 90 degrees (i.e orthogonal), and, in some embodiments 85-95 degrees (i.e. substantially orthogonal). As shown, the lamp units 102A and 102C are arranged in a horizontal direction, and the lamp unit 102B is arranged orthogonally with respect to the lamp units 102A and 102C, i.e. in a vertical direction. Moreover, said arrangement beneficially allows for overlapping of radiations emitted from the lamp units thereby providing a more even curing of the material as is indicated by the dashed lines in FIG. 1.

It should be noted that even though the lamp arrangement 100 disclosed herein is shown and exemplified as being one device, it should be noted that the lamp arrangement may comprise several devices that are arranged together to provide the lamp arrangement disclosed herein. In some such embodiments, each lamp unit may be a standalone device. In such embodiments the lamp units may be connected to a controller, or one of the lamp units may comprise the controller.

Referring to FIG. 2, shown is a schematic illustration of at least one lamp unit 200, in accordance with an embodiment of the invention. As shown, the at least one lamp unit 200 comprises a plurality of light sources, such as a light source 202A and a light source 202B, configured to emit radiations of pre-defined intensities. The lamp unit 200 may comprises a reflector 204 arranged around the light source 202A and the light source 202B. Alternatively two reflectors are arranged, each around one of the light sources.

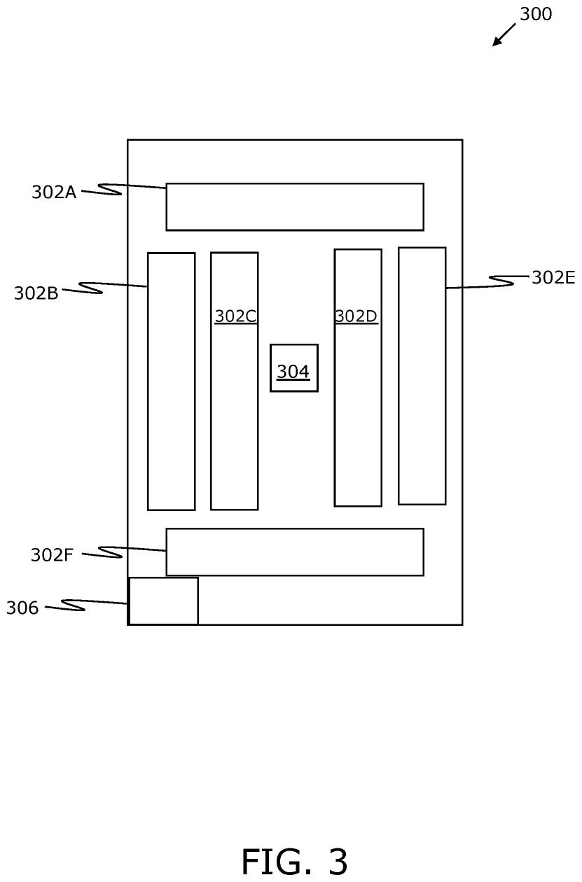

Referring to FIG. 3, shown is a schematic illustration of a lamp arrangement 300 for curing a material, in accordance with another embodiment of the invention. As shown, the lamp arrangement 300 comprises a plurality of lamp units, such as a lamp unit 302A, a lamp unit 302B, a lamp unit 302C, a lamp unit 302D, a lamp unit 302E, and a lamp unit 302F arranged in combination of a vertical and a horizontal alignment with each other, wherein the lamp units 302A and 302F are arranged in the horizontal direction with respect to each other, the lamp units 302B, 302C, 302D and 302E are arranged in the vertical direction with respect to each other, and the lamp units 302A and 302F are arranged orthogonally with respect to the lamp units 302B, 302C, 302D and 302E.

Moreover, the lamp arrangement 300 further comprises a sensor arrangement 304, wherein the sensor arrangement is configured to measure at least one parameter selected from: a distance, a temperature, an intensity of the radiation, and a humidity. It should be noted that the lamp arrangement 100 of FIG. 1 may also comprise such a sensor arrangement 304.

Furthermore, the lamp arrangement 300 comprises a controller 306 configured to control at least one parameter to provide the desired curing of the material.

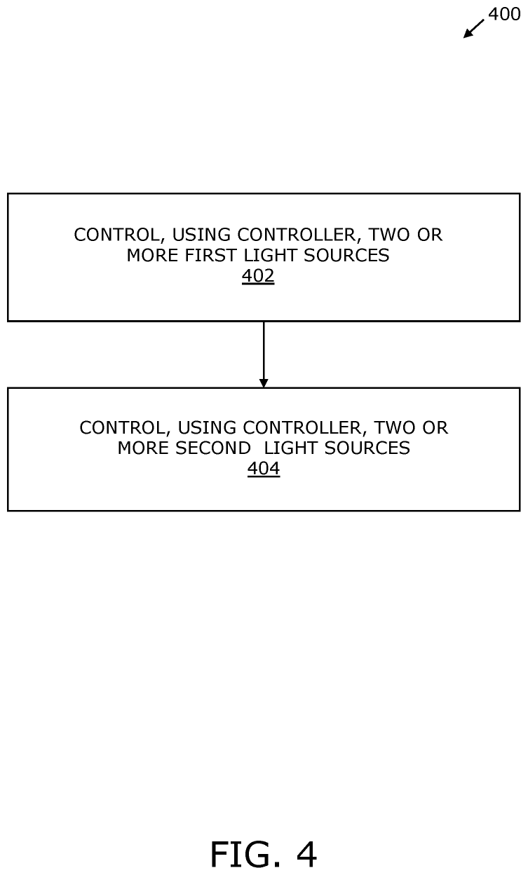

Referring to FIG. 4, shown is a flowchart showing a method 400 for curing a material, in accordance with an embodiment of the invention. The method relates to using a lamp arrangement as disclosed herein, the lamp arrangement comprising two or more lamp units, wherein each of the at two or more lamp units comprises a first light source configured to emit radiation of a first wavelength and a second light source configured to emit radiation of a second wavelength, wherein at least a first one of the two or more lamp units is arranged in a first direction and at least a second one of the two or more lamp units is arranged in a second direction, wherein the second direction is orthogonal to the first direction, and wherein the method comprises controlling 402 the intensity of the first light source and controlling 404 the intensity of the second light source based on the intensity of the first light source to provide a desired curing of the material.

The disclosure of the method 400 is only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A lamp arrangement for curing a material, the lamp arrangement comprising
a controller and
two or more lamp units, wherein each of the at two or more lamp units comprises
a first light source configured to emit radiation of a first wavelength and
a second light source configured to emit radiation of a second wavelength, wherein
at least a first one of the two or more lamp units is arranged in a first direction and at least a second one of the two or more lamp units is arranged in a second direction,
wherein the second direction is orthogonal to the first direction, and wherein
the controller is configured to control the intensity of the first light source and to control the intensity of the second light source based on the intensity of the first light source to provide a desired curing of the material.

2. The lamp arrangement according to claim 1, further comprising a sensor arrangement, wherein the sensor arrangement is configured to measure at least one parameter selected from: a distance, a temperature, and a humidity, and wherein the controller is configured to control the intensity of the first and second light source based on the measured at least one parameter.

3. The lamp arrangement according to claim 1, wherein the intensity of the second light source is in a range of 50-70% of the intensity of the first light source.

4. The lamp arrangement according to claim 1, wherein the controller is configured to
operate the first light source in a time period comprising a plurality of time slots and to selectively activate or deactivate the first light source in each time slot, wherein the number of time slots where the first light source is activated provides the intensity of the first light source, and to operate the second light source in the same time period and to selectively activate or deactivate the second light source in each time slot, wherein the number of time slots where the second light source is activated provides the intensity of the second light source,

5. The lamp arrangement according to claim 4, wherein the controller is configured to
operate the first light source at a first frequency of activation, and to operate the second light source at a second frequency of activation.

6. The lamp arrangement according to claim 4, wherein the controller is configured to
operate the first light source to activate in groups of time slots, and to operate the second light source to activate in groups of time slots.

7. The lamp arrangement according to claim 1, wherein the first wavelength corresponds to infrared medium wave radiation, and wherein the second wavelength corresponds to infrared short wave radiation.

8. The lamp arrangement according to claim 1, wherein one or more of the two or more lamp units comprises one lamp having two filaments, the first filament corresponding to the first light source and the second filament corresponding to the second light source.

9. The lamp arrangement according to claim 8, wherein the one or more of the two or more lamp units comprises a cassette and a reflector for both filaments housed in the cassette.

10. The lamp arrangement according to claim 8, wherein the one or more of the two or more lamp units comprises a cassette and two reflectors, one reflector for each filament, housed in the cassette.

11. The lamp arrangement according to claim 1, wherein one or more of the two or more lamp units comprises two lamps, the first lamp corresponding to the first light source and the second lamp corresponding to the second light source.

12. The lamp arrangement according to claim 11, wherein the one or more of the two or more lamp units comprises a cassette and a reflector for both lamps housed in the cassette.

13. The lamp arrangement according to claim 11, wherein the one or more of the two or more lamp units comprises a cassette and two reflectors, one reflector for each lamp, housed in the cassette.

14. The lamp arrangement according to claim 1, wherein the first direction is vertical and the second direction is horizontal.

15. The lamp arrangement according to claim 1, wherein at least one first lamp unit is arranged in the first direction and two lamp units are arranged in the second direction on opposite ends of the at least one first lamp unit with regards to the first direction.

16. The lamp arrangement according to claim 15, wherein there is one first lamp unit arranged in the first direction.

17. The lamp arrangement according to claim 15, wherein there are four first lamp units arranged in the first direction.

18. A method for use in a lamp arrangement for curing a material, the lamp arrangement comprising two or more lamp units, wherein each of the at two or more lamp units comprises
a first light source configured to emit radiation of a first wavelength and
a second light source configured to emit radiation of a second wavelength, wherein
at least a first one of the two or more lamp units is arranged in a first direction and at least a second one of the two or more lamp units is arranged in a second direction, wherein the second direction is orthogonal to the first direction, and wherein the method comprises
controlling the intensity of the first light source and controlling the intensity of the second light source based on the intensity of the first light source to provide a desired curing of the material.
